(19) United States
(12) Patent Application Publication
(10) Pub. No.: US 2008/0186412 A1
(43) Pub. Date: Aug. 7, 2008

(54) Remote Control with Integrated Optical Mouse Functionality

(75) Inventor: Henrik Johansson, Linkoping (SE)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/026,831

(22) Filed: Feb. 6, 2008

Related U.S. Application Data
(60) Provisional application No. 60/888,424, filed on Feb. 6, 2007.

(51) Int. Cl. G08C 19/00; G06F 3/033; H04N 5/44

(52) U.S. Cl. 348/734; 345/158; 340/825.72; 348/E05.103

(57) ABSTRACT

A device for identifying information on a remote video display is disclosed. The device includes a remote control having a housing with a first side and a second side, the second side defining at least one opening therein, at least one functional control located on the first side of the housing, and a camera/light module positioned inside the housing adjacent the second side, said camera/light module oriented so as to align a camera lens with, and project a light source through, the at least one opening away from the second side of the housing. A method for identifying information on a remote video display is also disclosed.

### CROSS-REFERENCE TO RELATED PATENT APPLICATIONS

This patent application claims the benefit of U.S. Provisional Patent Application No. 60/888,424, filed Feb. 6, 2007, which is incorporated by reference herein in its entirety.

### BACKGROUND

Remote control devices are well known in the art. These devices allow a user to turn on and off various electrical devices such as televisions, DVD players, stereos, and the like without having to come in direct contact with the electrical device itself. The remote control devices also allow a user to select, for example, a channel or frequency of a television or radio, as well as a particular CD track on a CD player. Remote control devices also allow a user to adjust the volume level of a particular electrical device, such as a television or stereo from a distance removed from the actual device.

When using a conventional remote control device, a user must usually point the device more or less directly at the equipment they wish to control using the device. Conventional remote control devices may permit rudimentary control of a pointer or cursor, by providing directional buttons (i.e., up, down, left, right) on a remote control. Some conventional remote control devices may offer a trackball or rubber pad on the remote control. Although precise control is not required for most functions accomplished through the use of a remote control, the fact that the control is not positioned on a supporting surface may, at times, make it difficult for a user to use the remote for certain tasks; for example, positioning a cursor on a remote video display.

An optical mouse is also well known in the art. Typically, such a mouse uses a small camera and red light to illuminate the surface that the camera monitors. Image processing is then used to determine how this camera/light module within the mouse moves in relation to its supporting surface. Because the optical mouse is supported on a surface such as a desk or counter top or a mouse pad, the mouse is more stable when being used than a hand-held remote control device. This allows the optical mouse to more precisely control a cursor on a display; for example, a computer monitor.

### BRIEF DESCRIPTION OF THE DRAWINGS

The accompanying figures where like reference numerals refer to identical or functionally similar elements throughout the separate views and which together with the detailed description below are incorporated in and from part of the specification, serve to further illustrate various embodiments and to explain various principles and advantages all in accordance with the present invention.

FIG. 1 is a top view of a conventional remote control device.

FIG. 2 is a bottom view of a conventional optical mouse showing the camera lens and light of the camera/light module.

FIG. 3A is a top view of a remote control device showing a top side along with a plurality of function controls according to an embodiment.

FIG. 3B is a bottom view of a remote control device showing a bottom side with an opening for a light and a camera lens according to an embodiment.

FIG. 4 is a perspective view showing the operation of a remote control device according to an embodiment.

FIG. 5 is a schematic showing the link between the remote control and the remote video display screen, according to an embodiment.

FIG. 6 is a flow chart describing the steps of a method in accordance with an embodiment.

### DETAILED DESCRIPTION OF THE EMBODIMENTS

Before describing in detail embodiments that are in accordance with the present invention, it should be observed that the embodiments reside primarily in combinations of apparatus components related to a remote control device for controlling a pointer or highlighter on a remote screen. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a remote control device for controlling a pointer or highlighter on a remote screen described herein. The non-processor circuits may include, but are not limited to, a radio receiver, a radio transmitter, signal drivers, clock circuits, power source circuits, and user input devices. As such, these functions may be interpreted as steps of a method to remotely control a pointer or highlighter on a remote screen. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Aspects of the invention provide more precise control of a pointer displayed as part of a graphical user interface in a remotely controlled environment. An illustrative example would be the control of a pointer or cursor in a web browser or other user interface running on a set-top box, and displayed on a monitor or television screen.

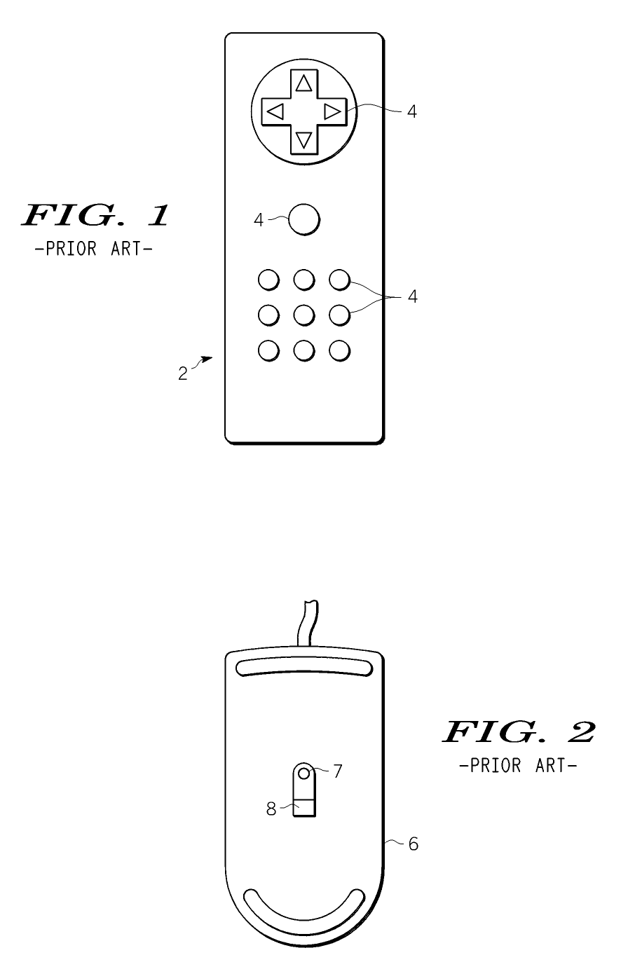

FIG. 1 shows a conventional remote control 2 that is used, for example, with a television, stereo, cable set-top box, or other electronic device. As seen in FIG. 1, a conventional remote control 2 has function keys 4 that allow an operator to, for example, select a channel or frequency on a television or stereo, or control a cursor appearing on a remote video display.

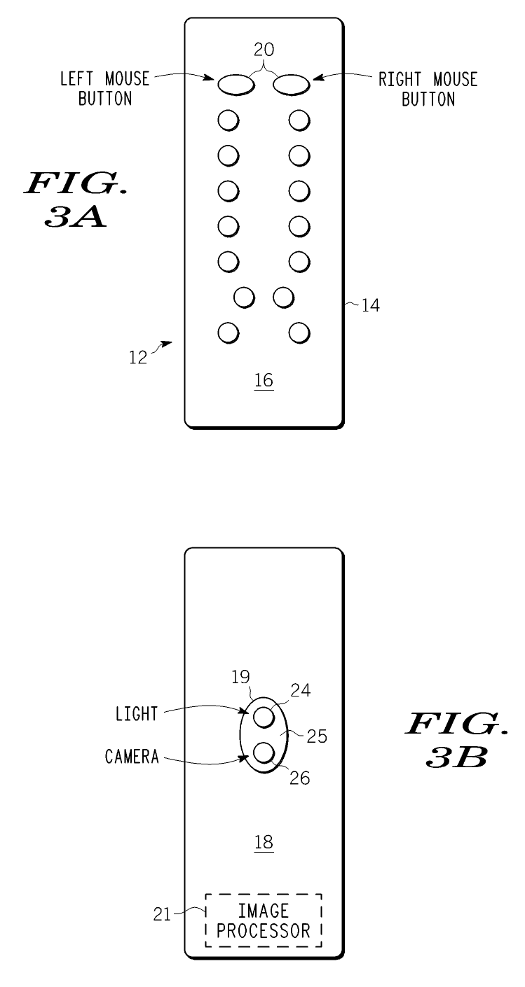

FIG. 2 shows the underside of a conventional optical mouse 6 that is used, for example, to control a cursor on a computer monitor. On the underside of the optical mouse 6 are the lens of a camera 7 and a light source 8.

FIGS. 3A and 3B illustrate an embodiment which includes a remote control 12 for identifying information on a remote video display 29, as shown in FIG. 5. As shown in FIGS. 3A and 3B, the remote control 12 has a housing 14 with a first side 16 and a second side 18. At least one functional control 20 is located on the first side 16 of the housing 12, and a camera/light module 25 is positioned inside the housing 14 adjacent the second side 18. The camera/light module 25 involves a light source 24 and a camera (e.g., photo sensor) 26, and is oriented so as to project a light source 24 through an opening 19 and away from the second side 18 of the housing 12. Camera 26 may, in some embodiments, comprise a photodiode or array of photodiodes.

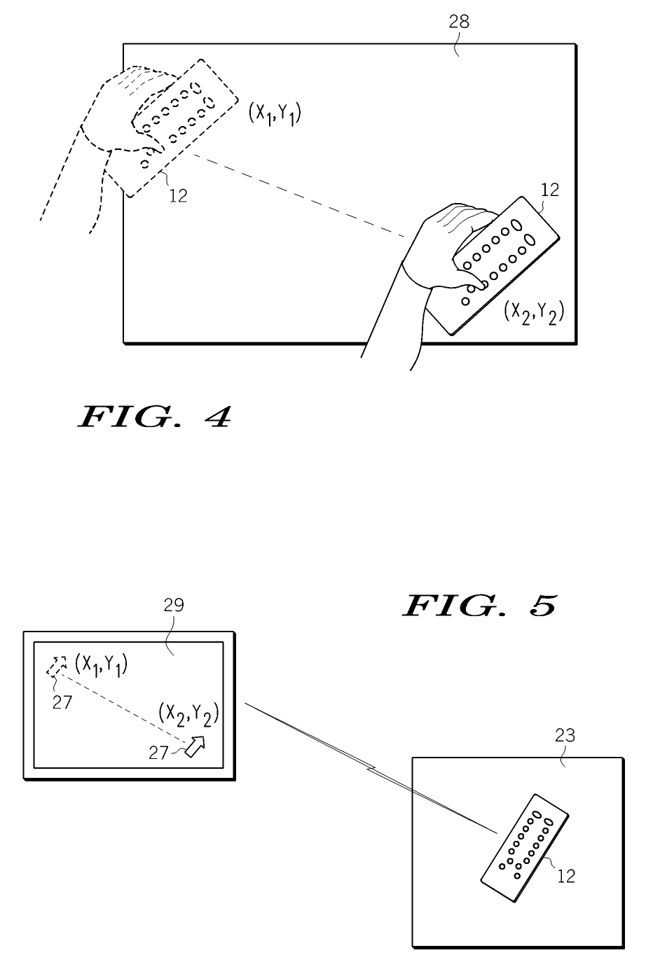

In an embodiment, image processing is used to determine the movement of the camera/light module 25 in relation to a surface 28 such as a counter top, desk top, furniture, or mouse pad. For example, as shown in FIG. 4, when a user moves the remote control 12 from a first position (x₁, y₁) on a surface 28 to a second position (x₂, y₂) the light 24 projecting through the second side 18 bounces off of the surface 28 onto a sensor (not shown), much like the functionality of an optical mouse. In an embodiment, light 24 is a red light; however, light 24 is not limited to red, and may comprise other colors or frequencies. The camera 26 takes multiple pictures every second, thereby allowing a processor (e.g., a digital signal processor) within the remote control 12 to detect patterns in the images generated by the camera 26, in a manner known in the art. These patterns allow the processor to determine how far the remote control 12 has moved sending a signal to smoothly move the indicator 27 by a proportionate amount on the remote screen or display 29, as shown in FIG. 5.

In an embodiment, the surface 28 may be non-rigid; for example, the camera/light module 25 is operable on surfaces such as carpet, a seat cushion, or the arm of a sofa or armchair. In a further embodiment, any of the camera 26, the light source 24, and the camera/light module 25 is dust-resistant; e.g., protected against foreign materials such as dust and fibers that may interferer with the operation of the camera/light module 25. For example, the camera/light module 25 may be wholly or partially sealed or covered, using material that is substantially transparent to light, or to the specific colors or frequencies of light emitted by light source 24 and/or received by camera 26.

In another embodiment, data that is transmitted from the remote control 12 to the remote video display 29 is controlled through the use of infra-red radiation in a manner well known in the art. In another embodiment, the data that is transmitted from the remote control 12 to the remote video display 29 is controlled through the use of a radio frequency based system, including wireless and Bluetooth, as shown in FIG. 5, thus eliminating the need to point any portion of the remote control 12 toward the equipment to be controlled using remote control 12.

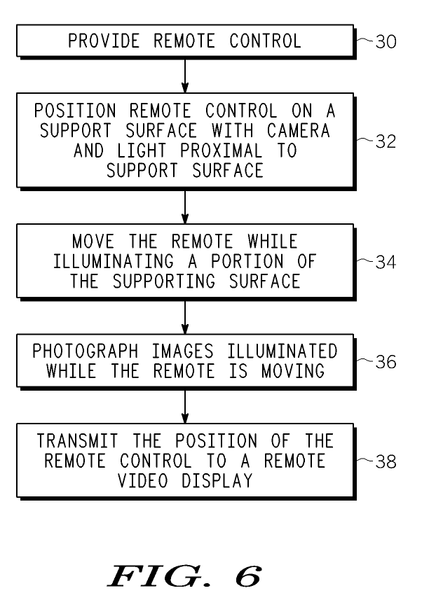

FIG. 6 illustrates exemplary steps carried out when moving the remote control 12 as shown in FIGS. 4 and 5, according to an embodiment. As illustrated, the method involves step 30 of providing a remote control device having a camera/light module, step 32 of positioning of the remote control device on a supporting surface such that a camera and light associated with the camera/light module are proximal to the supporting surface, step 34 of moving the remote control device along the supporting surface while illuminating a portion of the supporting surface with the light from the camera/light module; step 36 of photographing images illuminated by the light while the remote control is moving so as to identify the position of the device on the supporting surface, and step 38 of transmitting the position of the remote control device from the device to the remote video display.

In an embodiment of the method, the position of the remote control device is transmitted over a wireless communications link. The remote control may also be moved as a result of direct contact by a human being. The light emitter which may emit a red light may also be directed toward a particular position on the surface. The position of the control on the surface is determined using a camera to photograph the surface. In an embodiment, the surface may be non-rigid; for example, the camera/light module may be operable on surfaces such as a carpet, a seat cushion, or the arm of a sofa or armchair.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A device for controlling a video display, the device comprising:
a housing with a first side having at least one functional control located thereon for controlling the video display to display information, and a second side having a light emitter and a light sensor, the light emitter being configured to emit light away from the second side toward a surface and the light sensor being configured to detect the light reflected from the surface; and
a processor for determining a location of the housing relative to the surface based on the detected light and controlling the device to wirelessly send signals to the video display to control the video display to display an indication of the location of the device on the surface.

2. The device of claim 1, wherein the light emitter emits the light toward the surface and the light sensor detects the light reflected from the surface when the housing is moved along the surface, and the processor determining movement of the housing relative to the surface based on the detected light and controls the device to send signals to the video display to control the video display to display an indication representative of a relative movement of the device on the surface.

3. The device of claim 1, wherein the device further includes a wireless transmitter and the processor controls the wireless transmitter to transmit the signals wirelessly to the video display.

4. The device of claim 1, wherein the light emitter emits red light.

5. The device of claim 1, wherein the signals are infra-red radiation.

6. The device of claim 1, wherein the signals are radio frequency signals.

7. The device of claim 1, wherein the functional control controls a television receiver.

8. The device of claim 1, wherein the functional control controls a set-top box.

9. The device of claim 1, wherein the housing is movable by a human over the surface.

10. The device of claim 1, wherein the light emitter and light sensor are capable of operating on a non-rigid surface.

11. The device of claim 1, wherein the housing comprises dust-resistant material configured to protect the light emitter and light sensor.

12. A method for controlling a video display, the method comprising:
providing a remote control device having at least one functional control for controlling the video display to display information, and a light emitter and a light sensor;
positioning the remote control device on a surface;
operating the light emitter to emit light away from the second side toward the surface and operating the light sensor to detect the light reflected from the surface;
determining a location of the remote control device relative to the surface based on the detected light; and
operating the device to wirelessly send signals to the video display to control the video display to display an indication of the location of the remote control device on the surface.

13. The method of claim 12, further comprising:
moving the remote control device along the surface while operating the light emitter to emit the light toward the surface and operating the light sensor to detect the light reflected from the surface when the housing is moved along the surface;
determining movement of the remote control device relative to the surface based on the detected light; and
operating the remote control device to send signals to the video display to control the video display to display an indication representative of a relative movement of the remote control device on the surface.

14. The method of claim 12, wherein the step of operating the device to send signals comprises transmitting the signals over a wireless communications link.

15. The method of claim 12 further comprising the step of directing the light emitter to a particular position on the surface.

16. The method of claim 12, wherein the light emitter emits a red light.

17. The method of claim 13, wherein the moving step is accomplished by a human over the surface.

18. The method of claim 13, wherein the determining step is accomplished using a camera to photograph the position of the remote control on the surface.

19. The method of claim 12, wherein the remote control device is positioned on a non-rigid surface.

20. The method of claim 12, wherein the remote control device controls a television receiver.

21. The method of claim 12, wherein the remote control device controls a set-top box.
